(19) United States
(12) Patent Application Publication
(10) Pub. No.: US 2015/0266150 A1
(43) Pub. Date: Sep. 24, 2015

(54) TOOL CHANGING METHOD FOR MACHINE TOOL

(71) Applicant: MITSUBISHI HEAVY INDUSTRIES, LTD., Tokyo (JP)

(72) Inventors: Yohei KOMATSU, Tokyo (JP); Keisuke YOSHIKAWA, Tokyo (JP)

(73) Assignee: MITSUBISHI HEAVY INDUSTRIES, LTD., Tokyo (JP)

(21) Appl. No.: 14/661,745

(22) Filed: Mar. 18, 2015

(30) Foreign Application Priority Data
Mar. 20, 2014 (JP) 2014-057543

(51) Int. Cl. B23Q 3/157

(52) U.S. Cl. CPC B23Q 3/15706

(57) ABSTRACT

A tool changing method for a machine tool configured to machine a workpiece with a long tool by three-dimensionally moving the long tool and the workpiece relative to each other, the long tool being detachably provided to a spindle, the workpiece being placed on a table, the tool changing method including: transporting the long tool in such a way as to place the long tool onto the table with a long-tool supporting base therebetween by using a gantry loader configured to transport the workpiece in such a way as to place the workpiece onto the table; and then three-dimensionally moving the table and the spindle relative to each other to thereby attach the long tool to the spindle.

### TECHNICAL FIELD

The present invention relates to a tool changing method for attaching and detaching a long tool to and from the spindle of a machine tool such as a machining center for changing its tool.

### BACKGROUND ART

A machine tool such as a machining center is designed to be capable of automatically changing its tool on the spindle among various tools housed in a tool magazine by using a tool changing device. In a case where such a machine tool utilizes long tools (e.g. approximately 1000 mm) longer than generally-used tools' lengths (around 500 mm), these long tools cannot be housed in the tool magazine. In view of this, a tool changing device has been proposed which, for example, is provided with a rack-type long-tool magazine configured to house long tools, and is configured to move the long-tool magazine to the vicinity of a spindle so that a desired long tool can be positioned in the vicinity of the spindle and the long tool can be attached to the spindle (see Patent Literature 1 listed below, for example).

### CITATION LIST

### Patent Literatures

### {Patent Literature 1} Japanese Patent Application Publication No. 2008-023661

### {Patent Literature 2} Japanese Patent Application Publication No. 2005-103650

### SUMMARY OF INVENTION

### Technical Problems

However, since a tool changing device as mentioned above is configured to move the long tools together with the long-tool magazine, a driving device for moving the long-tool magazine is so large that the installation is difficult and also the cost increases.

In view of the above, an object of the present invention is to provide a tool changing method for a machine tool capable of attaching and detaching a long tool to and from a spindle for changing its tool in a smaller space at a lower cost.

### Solution to Problems

A tool changing method for a machine tool according to a first aspect of the invention for solving the above problems provides a tool changing method for a machine tool configured to machine a workpiece with a long tool by three-dimensionally moving the long tool and the workpiece relative to each other, the long tool being detachably provided to a spindle, the workpiece being placed on a table, the tool changing method including: transporting the long tool in such a way as to place the long tool onto the table by using a gantry loader configured to transport the workpiece in such a way as to place the workpiece onto the table; and then three-dimensionally moving the table and the spindle relative to each other to thereby attach the long tool to the spindle.

Also, a tool changing method for a machine tool according to a second aspect of the invention provides the first aspect of the invention, further including: three-dimensionally moving the spindle to which the long tool is attached and the table relative to each other to thereby place the long tool from the spindle onto the table; and then transporting the long tool in such a way as to take the long tool off the table by using the gantry loader.

Also, a tool changing method for a machine tool according to a third aspect of the invention provides the first aspect of the invention, further including: arranging a long-tool supporting base configured to support the long tool onto the table of the machine tool; and placing the long tool onto the table with the long-tool supporting base therebetween.

Also, a tool changing method for a machine tool according to a fourth aspect of the invention provides the first aspect of the invention, in which the gantry loader includes holding means capable of switching between detachably holding of the workpiece and detachably holding of the long tool.

### Advantageous Effects of Invention

According to the tool changing methods for a machine tool according to the present invention, attachment and detachment of a long tool to and from the spindle can be done without preparing a major driving device exclusively for changing the tool to or from the long tool. Thus, it is possible to attach and detach a long tool to and from the spindle of the machine tool for changing its tool in a smaller space at a lower cost.

### BRIEF DESCRIPTION OF DRAWINGS

FIG. 1 is an entire explanatory view of a main embodiment of a tool changing method for a machine tool according to the present invention;

FIG. 2 is an enlarged explanatory view of a chief part of FIG. 1; and

FIG. 3 is a side view of FIG. 2.

FIG. 4 is a view of a state where a workpiece is gripped with a double-handed unit of a gantry loader.

### DESCRIPTION OF EMBODIMENTS

A tool changing method for a machine tool according to the present invention will be described with reference to the drawings. However, the present invention is not limited only to the embodiment to be described below with reference to the drawings.

### Main Embodiment

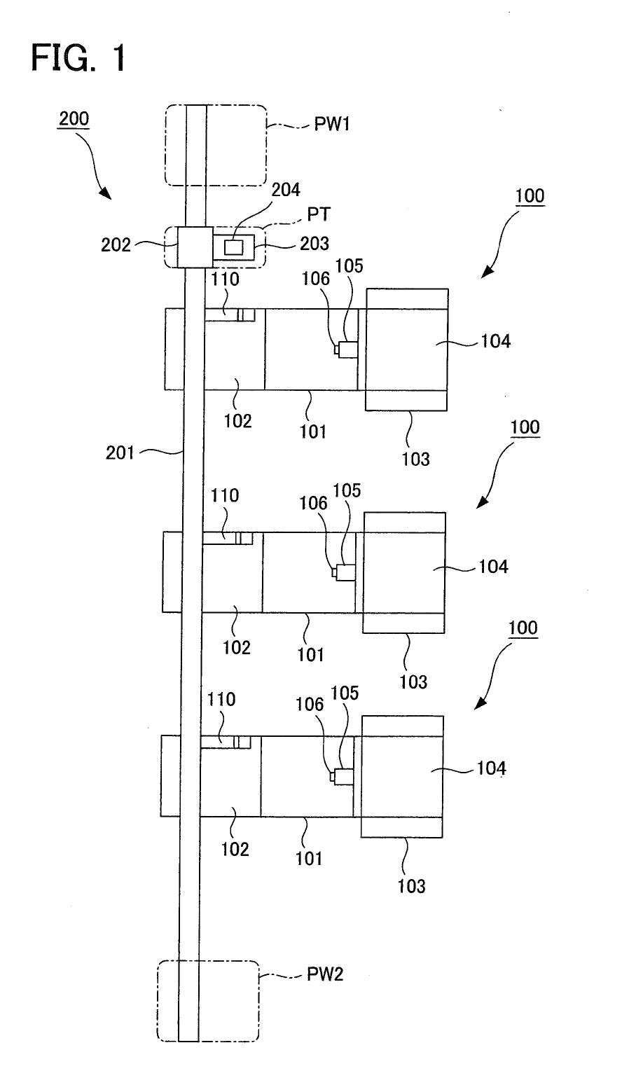

A main embodiment of the tool changing method for a machine tool according to the present invention will be described with reference to FIGS. 1 to 4.

As shown in FIG. 1, in a facility for machining a workpiece such as a cylinder block, for example, multiple (three in this embodiment) machining centers 100, which are machine tools, are arranged, and a rail 201 for a gantry loader 200 is laid on the ceiling side in such a way as to connect spaces above tables 102 of these machining centers 100 to each other. By using the gantry loader 200, a workpiece prepared in an unmachined workpiece storing place PW1 can be transported to and placed onto the table 102 of one machining center 100; moreover, the workpiece machined on the table 102 of this machining center 100 can be transported to and transferred onto the table 102 of a different machining center 100, and different machining can further be performed by the machining center 100; furthermore, the workpiece after the machining by these machining centers 100 can be transported to a machined workpiece storing place PW2 and temporarily stored there.

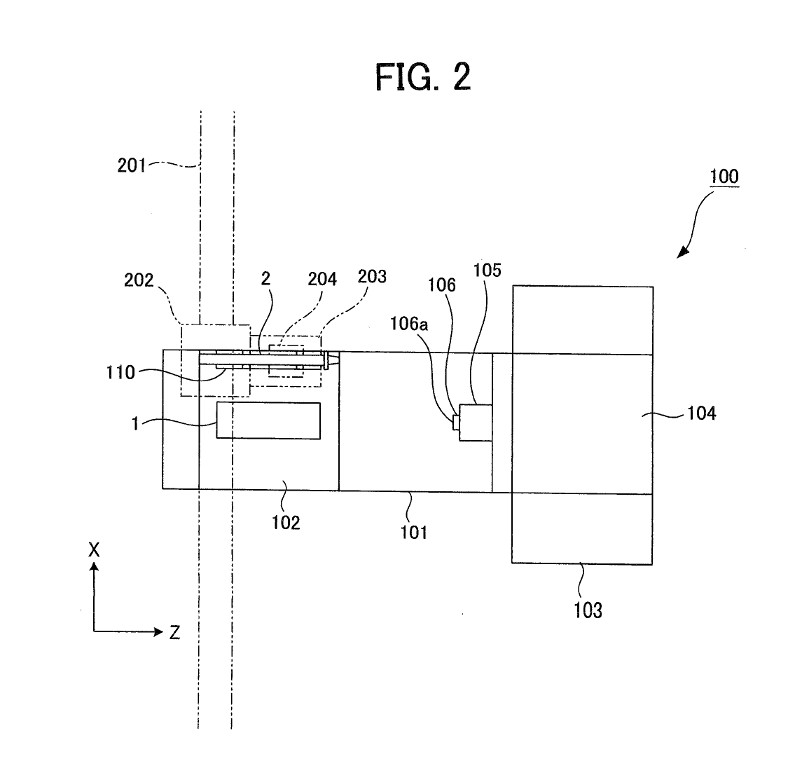

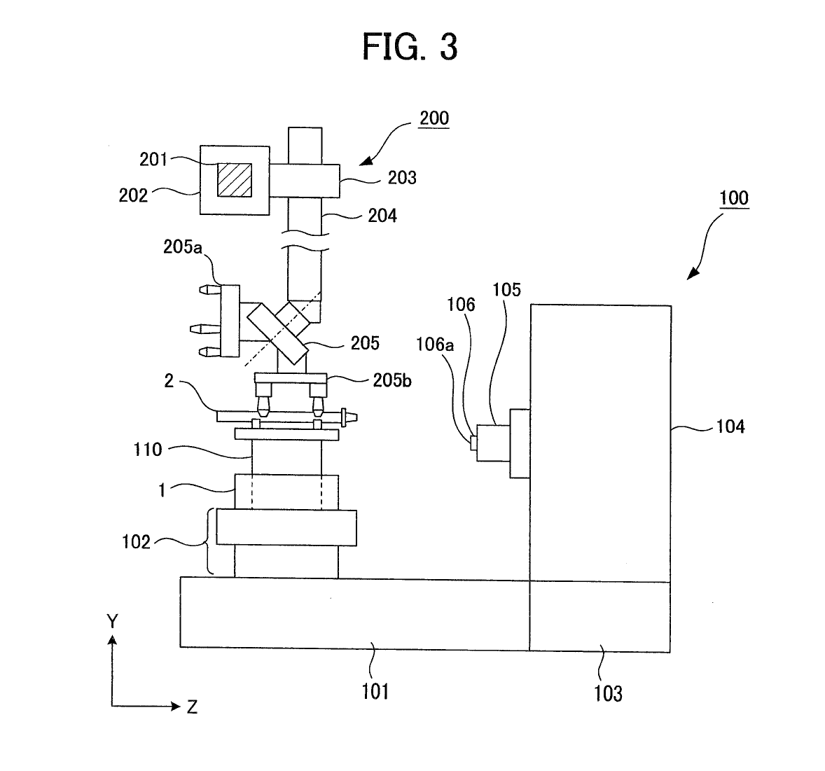

As shown in FIGS. 2 and 3, in each machining center 100, the table 102 is arranged on a bed 101. The table 102 is capable of moving (in the Z-axis direction) along the upper surface (guide surface) of the bed 101 and also of turning (about the Y axis) at a horizontal plane.

Moreover, a column 104 is arranged on a bed 103. The column 104 is capable of moving (in the X-axis direction) along the upper surface (guide surface) of the bed 103. A spindle head 105 is attached to the front surface of the column 104. The spindle head 105 is capable of moving (in the Y-axis direction) along the front surface (guide surface) of the column 104. Note that in each of FIGS. 2 and 3, reference signs 106 and 106a denote a spindle and a spindle tip, respectively.

Each machining center 100 further includes a tool magazine configured to house tools of general lengths (around 500 mm) and a tool changing device (not shown) configured to change the tool at the spindle tip 106a of the spindle 106 to a desired tool in the tool magazine.

On the other hand, the gantry loader 200 includes a moving unit 202 attached to the rail 201. The moving unit 202 is capable of moving along the rail 201. A supporting unit 203 configured to support a beam 204 longitudinally oriented along the vertical direction (the Y-axis direction in FIGS. 2 and 3) is attached to the moving unit 202. The supporting unit 203 is capable of lifting and lowering the beam 204.

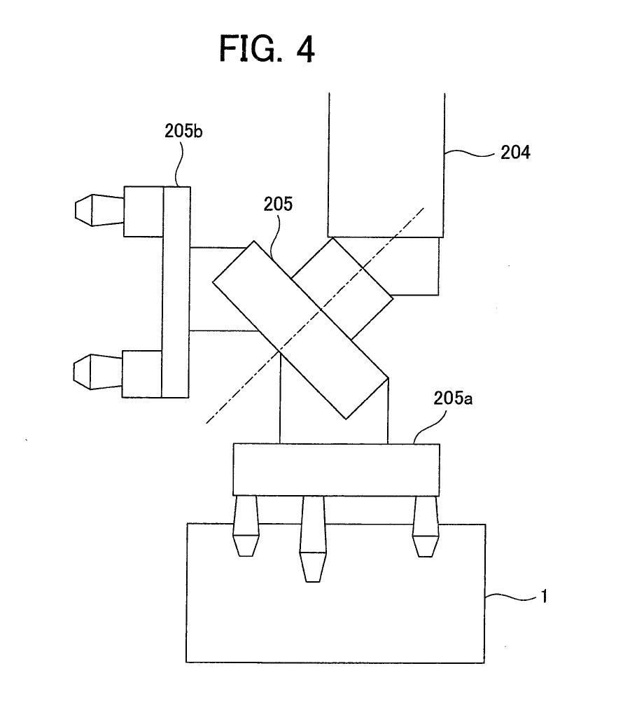

A double-handed unit 205 which is swivel-type holding means is attached to a tip (lower end) of the beam 204. The double-handed unit 205 includes a workpiece hand 205a configured to detachably hold a workpiece 1 and a long-tool hand 205b configured to detachably hold a long tool 2. The double-handed unit 205 is capable of switching its hand between the workpiece hand 205a and the long-tool hand 205b such that one of them faces downward (see FIGS. 3 and 4).

Moreover, a long-tool supporting base 110 configured to support the long tool 2 is arranged on the table 102 of the machining center 100 on one side in the X-axis direction (upper side in FIG. 2). The long-tool supporting base 110 has a positioning groove configured to support the long tool 2 at a predetermined position in the X-axis direction. Note that in FIG. 1, reference sign PT denotes a long-tool storing place.

In the facility including the machining centers 100 and the gantry loader 200 as described above, the workpiece 1 is machined as follows. First, the hand of the double-handed unit 205 of the gantry loader 200 is switched to make the workpiece hand 205a face downward.

Then, the workpiece 1 prepared in the unmachined workpiece storing place PW1 is held by the workpiece hand 205a of the gantry loader 200, and the beam 204 is moved upward by the supporting unit 203 to lift the workpiece 1. Moreover, the supporting unit 203 is caused to run along the rail 201 by means of the moving unit 202 to transport the workpiece 1 to the space above the table 102 of the closest machining center 100 (e.g. the one at the top in FIG. 1). Then, the beam 204 is moved downward by the supporting unit 203 to lower and place the workpiece 1 onto the table 102, and the workpiece 1 is released from the workpiece hand 205a. Thereafter, the beam 204 is moved upward by the supporting unit 203. Also, the moving unit 202 is caused to run along the rail 201 to move the double-handed unit 205 to a retreat position.

Subsequently, a desired tool in the tool magazine is attached to the spindle 106 of the machining center 100 by the tool changing device. Then, with the spindle 106 being rotated, the table 102 is moved in the Z-axis direction and turned about the Y axis, the column 104 is moved in the X-axis direction, and the spindle head 105 is moved in the Y-axis direction. As a result, the workpiece 1 and the tool are three-dimensionally moved relative to each other, thereby performing machining on the workpiece 1 with the tool of a general length.

In a case, for example, of performing machining with the long tool 2 after the machining with the tool of the general length as described above is finished, the tool at the spindle 106 of the machining center 100 is housed to the tool magazine by the tool changing device. Also, the hand of the double-handed unit 205 of the gantry loader 200 is switched to make the long-tool hand 205b face downward.

Then, the moving unit 202 is moved along the rail 201 such that the double-handed unit 205 of the gantry loader 200 can be positioned above the long-tool storing place PT. The supporting unit 203 and the long-tool hand 205b are operated such that the long tool 2 prepared in the long-tool storing place PT can be held by the long-tool hand 205b. The moving unit 202 and the supporting unit 203 are operated such that the long tool 2 can be placed onto the table 102 of the machining center 100 with the long-tool supporting base 110 therebetween. After the long tool 2 is released from the long-tool hand 205b, the beam 204 is moved upward by the supporting unit 203. Also, the moving unit 202 is caused to run along the rail 201 to move the double-handed unit 205 to the retreat position.

Thereafter, the column 104 and the spindle head 105 are moved such that the position of the axis of the spindle 106 of the machining center 100 and the position of the axis of the long tool 2 on the long-tool supporting base 110 can coincide with each other in the X-axis direction and the Y-axis direction. Then, the table 102 is moved in the Z-axis direction toward the column 104. As a result, the table 102 and the spindle 106 are three-dimensionally moved relative to each other, thereby attaching the long tool 2 to the spindle tip 106a of the spindle 106.

Subsequently, with the spindle 106 being rotated, the table 102 is moved in the Z-axis direction and turned about the Y axis, the column 104 is moved in the X-axis direction, and the spindle head 105 is moved in the Y-axis direction. As a result, the workpiece 1 and the long tool 2 are three-dimensionally moved relatively to each other, thereby performing machining on the workpiece 1 with the long tool 2.

Once the machining with the long tool 2 as described above is finished, the machining center 100 and the gantry loader 200 are operated in an order reverse to that of the operation described above, so that the long tool 2 attached to the spindle 106 is placed onto the long-tool supporting base 110 on the table 102 and the long tool 2 is detached from the spindle 106. Then, the long tool 2 is transported such that the long tool 2 can be taken off the long-tool supporting base 110, and returned to the long-tool storing place PT.

Then, for example, the workpiece 1 machined by the machining center 100 is transported to and transferred onto the table 102 of a different machining center 100 by the gantry loader 200 and, for example, different machining is further performed on the workpiece 1 in a manner similar to the above. Thereafter, operation similar to the above is repeated. Once all the machining on the workpiece 1 by the machining centers 100 is finished, the workpiece 1 is transported to the machined workpiece storing place PW2 by the gantry loader 200 and temporarily stored there.

In sum, in this embodiment, the long tool 2 is attached to and detached from the spindle 106 by: placing the long tool 2 onto the table 102 of the machining center 100 with the long-tool supporting base 110 therebetween by using the gantry loader 200 configured to transport the workpiece 1 onto the table 102 of the machining center 100; and three-dimensionally moving the table 102 of the machining center 100 and the spindle 106 relative to each other.

For this reason, in this embodiment, the attachment and detachment of the long tool 2 to and from the spindle 106 can be done without preparing a major driving device exclusively for changing the tool to or from the long tool 2, simply by providing the double-handed unit 205 to the beam 204 of the gantry loader 200 and arranging the long-tool supporting base 110 on the table 102 of the machining center 100.

Thus, according to this embodiment, it is possible to attach and detach the long tool 2 to and from the spindle 106 of the machining center 100 for changing its tool in a smaller space at a lower cost.

### Other Embodiments

Here, in the above embodiment, the case is described in which the gantry loader 200 including the double-handed unit 205 including the workpiece hand 205a and the long-tool hand 205b in a switchable manner is employed. However, as another embodiment, the workpiece and the long tool can, for example, be held by the same single holding means without switching operation, depending upon the shapes and the like of the workpiece and the long tool.

Morever, in the above embodiment, the long-tool supporting base 110 is arranged on the table 102 of the machining center 100 on the one side in the X-axis direction (upper side in FIG. 2), i.e., a position at which the long-tool supporting base 110 does not obstruct machining of the workpiece 1, and the machining of the workpiece 1 is performed with the long-tool supporting base 110 placed on the table 102. However, as yet another embodiment, it is possible, for example, to place the long-tool supporting base 110 on the table 102 only when the long tool 2 is attached to and detached from the spindle 106, and put the long-tool supporting base 110 away from the table 102 when machining is performed on the workpiece 1, depending upon the shape, size, machining position, and the like of the workpiece 1.

Furthermore, in the above embodiment, the long tool 2 is placed on the table 102 of the machining center 100 with the long-tool supporting base 110 therebetween. However, as still another embodiment, the long tool 2 can be attached to and detached from the spindle tip 106a of the spindle 106 by, for example, not using the long-tool supporting base 110 but directly placing the long tool 2 on the table 102 and three-dimensionally moving the table 102 and the spindle 106 relative to each other, depending upon the shapes, sizes, and the like of the long tool 2 and the table 102.

### INDUSTRIAL APPLICABILITY

The tool changing method for a machine tool according to the present invention is capable of attaching and detaching a long tool to and from the spindle of a machine tool for changing the tool thereof in a smaller space at a lower cost, and can therefore be used significantly beneficially in the industries of machining various materials including metals.

### REFERENCE SIGNS LIST

1 workpiece
2 long tool
100 machining center
101 bed
102 table
102a turn shaft
102b holding device
103 bed
104 column
105 spindle head
106 spindle
106a spindle tip
107a, 107b pallet
110 long-tool supporting base
200 automated guided vehicle (agv)
201 mast
202 fork
210 guide line

1. A tool changing method for a machine tool configured to machine a workpiece with a long tool by three-dimensionally moving the long tool and the workpiece relative to each other, the long tool being detachably provided to a spindle, the workpiece being placed on a table, the tool changing method comprising:
transporting the long tool in such a way as to place the long tool onto the table by using a gantry loader configured to transport the workpiece in such a way as to place the workpiece onto the table; and
then three-dimensionally moving the table and the spindle relative to each other to thereby attach the long tool to the spindle.

2. The tool changing method for a machine tool according to claim 1, further comprising:
three-dimensionally moving the spindle to which the long tool is attached and the table relative to each other to thereby place the long tool from the spindle onto the table; and
then transporting the long tool in such a way as to take the long tool off the table by using the gantry loader.

3. The tool changing method for a machine tool according to claim 1, further comprising:
arranging a long-tool supporting base configured to support the long tool onto the table of the machine tool; and
placing the long tool onto the table with the long-tool supporting base therebetween.

4. The tool changing method for a machine tool according to claim 1, wherein the gantry loader includes holding means capable of switching between detachably holding of the workpiece and detachably holding of the long tool.
